(19) United States
(12) Patent Application Publication
(10) Pub. No.: US 2026/0302753 A1
(43) Pub. Date: Oct. 1, 2026

(54) UTILITY HANDHOLES

(71) Applicant: AFL Telecommunications LLC, Duncan, SC (US)

(72) Inventors: Charles Turlington, Jr., Simpsonville, SC (US); Mark Vogel, Greenville, SC (US); Ted Lichoulas, Simpsonville, SC (US); Jerry Stepp, Fountain Inn, SC (US)

(21) Appl. No.: 19/479,542

(22) PCT Filed: Apr. 26, 2024
(86) PCT No.: PCT/US2024/026442

§ 371 Date: Oct. 28, 2025

Related U.S. Application Data
(60) Provisional application No. 63/462,665, filed on Apr. 28, 2023.

(51) Int. Cl. H02G 9/10; E02D 29/12; E02D 29/14

(52) U.S. Cl. CPC H02G 9/10; E02D 29/124; E02D 29/1472

(57) ABSTRACT

A utility handhole includes a main body including a plurality of panels, each of the plurality of panels including an interior surface and an exterior surface and defining a plurality of ribs. At least a portion of the plurality of ribs extend along a vertical axis and are connected to form an integral panel backbone. Each of the plurality of panels is hingedly connected to at least two others of the plurality of panels, such that the main body is movable between a folded position and an expanded position. Each of the plurality of panels is formed from a foamed thermoplastic material.

### CROSS-REFERENCE TO RELATED APPLICATIONS

The present application claims priority to U.S. Provisional Patent Application No. 63/462,665 filed on Apr. 28, 2023, the disclosure of which is incorporated by reference herein in its entirety.

### FIELD

The present disclosure relates generally to containment vaults, also known as handholes, for use in various industries such as telecommunications, water, etc.

### BACKGROUND

A significant problem with large handholes is their bulky sizes/weight as it relates to storage, shipping, and installation. Installation often involves either multiple installers or the use of heavy equipment (e.g., backhoe). Additionally, some known vault designs consist of a single piece box-structure, which can be particularly heavy and difficult to transport and install.

Further, a significant problem with large handhole covers is their relatively low strength-to-weight ratio. This is particularly true for Tier 22 rated vaults. This can create issues for installers and maintenance personnel who have to access the interior of the vault in order to, for example, terminate or repair fiber optic slices. In addition, unsecured covers can often become dislodged under hydraulic pressure during flooding if the installers neglect to secure the “traditional” lag bolts that accompany the typical vault cover.

Accordingly, improved handholes would be advantageous. Specifically, handholes which address one or more of the above-stated deficiencies would be advantageous.

### BRIEF DESCRIPTION

Aspects and advantages of the present disclosure will be set forth in part in the following description, or may be obvious from the description, or may be learned through practice of the technology.

In accordance with one embodiment, a utility handhole is provided. The utility handhole includes a main body including a plurality of panels, each of the plurality of panels including an interior surface and an exterior surface and defining a plurality of ribs. At least a portion of the plurality of ribs extend along a vertical axis and are connected to form an integral panel backbone. Each of the plurality of panels is hingedly connected to at least two others of the plurality of panels, such that the main body is movable between a folded position and an expanded position. Each of the plurality of panels is formed from a foamed thermoplastic material.

In accordance with another embodiment, a utility handhole is provided. The utility handhole includes a main body including a plurality of panels, each of the plurality of panels including an interior surface and an exterior surface and defining a plurality of ribs. At least a portion of the plurality of ribs extend along a vertical axis and are connected to form an integral panel backbone. Each of the plurality of panels is formed from a foamed thermoplastic material. The utility handhole further includes a cover. The cover includes a plurality of strength rods embedded in a fiber-reinforced thermoset material. The strength rods are defined in ribs formed by the fiber-reinforced thermoset material.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a handhole in an expanded position in accordance with embodiments of the present disclosure;

FIG. 2 is a perspective view of the handhole of FIG. 1 in a folded position in accordance with embodiments of the present disclosure;

FIG. 3 is a top view of the handhole of FIG. 2 in accordance with embodiments of the present disclosure;

FIG. 4 is a perspective view illustrating a hinge pin connecting panels of a handhole in accordance with embodiments of the present disclosure;

FIG. 5 is a top cross-sectional view of a handhole in an expanded position in accordance with embodiments of the present disclosure;

FIG. 6 is a perspective view of a handhole including a collar in accordance with embodiments of the present disclosure;

FIG. 7 is a side cross-sectional view of a handhole including a collar in accordance with embodiments of the present disclosure;

FIG. 8 is a perspective view of a handhole including a collar and a riser in accordance with embodiments of the present disclosure;

FIG. 9 is a perspective view of a cover for a handhole in accordance with embodiments of the present disclosure;

FIG. 10 is a perspective view of a handhole including a collar and a cover in accordance with embodiments of the present disclosure;

FIG. 11 is a perspective view of a handhole in an expanded position in accordance with embodiments of the present disclosure;

FIG. 12 is a perspective view of the handhole of FIG. 11 in a folded position in accordance with embodiments of the present disclosure;

FIG. 13 is a perspective view illustrating fasteners connecting panels of a handhole in accordance with embodiments of the present disclosure;

FIG. 14 is a close-up perspective view illustrating a fastener connecting panels of a handhole in accordance with embodiments of the present disclosure;

FIG. 15 is a perspective view of a handhole in an expanded position in accordance with embodiments of the present disclosure;

FIG. 16 is a perspective view of a cover for a handhole in accordance with embodiments of the present disclosure;

FIG. 17 is a perspective view of a handhole including a cover in accordance with embodiments of the present disclosure;

FIG. 18 is a perspective view of a handhole including a cross-brace in accordance with embodiments of the present disclosure;

FIG. 19 is a semi-transparent view of a cover for a handhole in accordance with embodiments of the present disclosure;

FIG. 20 is a semi-transparent view of a cover for a handhole in accordance with other embodiments of the present disclosure;

FIG. 21 is a semi-transparent view of a cover for a handhole in accordance with other embodiments of the present disclosure;

FIG. 22 is a semi-transparent view of a cover for a handhole in accordance with other embodiments of the present disclosure; and

FIG. 23 is a side-by-side comparison of handhole panels formed using modular molds in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure provides improved utility handholes which address one or more of the above-described deficiencies of known handholes. For example, such handholes may provide high strength-to-weight ratios while also being lightweight and easily transportable. Further, such handholes may include improved covers which are secure while also providing improved strength-to-weight ratios.

In exemplary embodiments, handholes in accordance with the present disclosure are Tier 22 rated handholes. It should be understood, however, that the present disclosure is not so limited.

Referring now to the Figures, embodiments of utility handholes 10 are provided. A mutually orthogonal coordinate system may be defined for such handholes 10, and may include a longitudinal axis 12, a lateral axis 14, and a vertical axis 16, as shown.

A handhole 10 may include a main body 20 which includes a plurality of panels 22. Each of the plurality of panels 22 includes an interior surface 24 and an exterior surface 26. The panels 22 may be connected together to generally define an interior 28. In exemplary embodiments, four panels 22 may be utilized. Alternatively, two, three, five, six, or more panels 22 may be utilized.

Each panel 22 may further extend along the vertical axis 16 between a bottom 30 and a top 32, and may extend in a direction perpendicular to the vertical axis 16, such as laterally or longitudinally, between a first side 34 and a second side 36. The first and second sides 34, 36 of each of the plurality of panels 22 may be connected to others of the plurality of panels 22 to form the main body 20. In exemplary embodiments, each panel 22 is connected to at least two others of the plurality of panels 22.

In exemplary embodiments, each panel 22 of the plurality of panels 22 is formed from a foamed thermoplastic material. In some embodiments, the material may be a polyethylene, such as for example a high-density polyethylene. Alternatively, in some embodiments, the material may be a polyurethane, such as for example a high-density polyurethane. Alternatively, in some embodiments, the material may be a polypropylene, such as for example a high-density polypropylene.

In some embodiments, due to the structure of the panels 22 as discussed herein, no reinforcing fibers (e.g. glass fibers, carbon fibers, etc.) are required to be included in the foamed thermoplastic material of the panels 22. Alternatively, however, reinforcing fibers, such as glass fibers or carbon fibers, may be included. Further, in exemplary embodiments, no embedded strength rods are required to be included in the foamed thermoplastic material of the panels 22. Alternatively, however, embedded strength rods could be included if desired.

In exemplary embodiments, each of the plurality of panels 22 include a plurality of ribs 40 defined therein. The ribs 40 are formed from the material which forms the panel 22, such as the foamed thermoplastic material, and are thus integral components of the panel 22. In exemplary embodiments, ribs 40 may extend between and be defined by the interior surface 24 and the exterior surface 26, such that the ribs 40 provides structural support on both the interior and exterior sides (and throughout the thickness of) the panel 22.

In exemplary embodiments, each panel 22 may include one or more, such as a plurality of, ribs 40 which extend along the vertical axis 16. In exemplary embodiments, one or more of the vertically extending ribs 40 may extend from the bottom 30 of a panel 22 to the top 32 of the panel 22, and thus throughout a full length of the panel 22 at the location of the rib 40. Additionally or alternatively, one or more of the vertically extending ribs 40 may extend through only a portion of a length of a rib 40. Further, in some exemplary embodiments, each panel 22 may include one or more, such as a plurality of, ribs 40 which extend in a direction perpendicular to the vertical axis 16, such as laterally or longitudinally. In exemplary embodiments, one or more of the perpendicularly extending ribs 40 may extend from the first side 34 of a panel 22 to the second side 36 of the panel 22, and thus throughout a full width of the panel 22 at the location of the rib 40. Additionally or alternatively, one or more of the perpendicularly extending ribs 40 may extend through only a portion of a width of a rib 40.

Referring now specifically to FIG. 5, in exemplary embodiments, one or more of the vertically extending ribs may be connected to form an integral panel backbone 42. In an integral panel backbone 42, the ribs 40 are connected to each other such that force imparted on one or more of the ribs 40 in the backbone 42 is distributed throughout the backbone 42. To facilitate a connection, in some embodiments, one or more of the ribs 40 may have a U-shaped cross-sectional profile, as shown in FIG. 5. These U-shaped ribs 40 may in exemplary embodiments extend along the vertical axis 16, such as through a full length, approximately a full length, or a portion of a full length of a panel 22, and may act as column-like strength members for the panel 22. Further, in some embodiments, one or more widthwise extending ribs 40 may extend through and connect neighboring vertical ribs 40, as shown.

In some embodiments, one or more of the ribs 40 which form the backbone 42 may extend between and be defined by the interior surface 24 and the exterior surface 26. Further, in some embodiments, one or more of the ribs 40 which form the backbone 42 may extend from the bottom 30 of the panel 22 to the top 32 of the panel 22, and thus throughout a full length of the panel 22 at the location of the rib 40.

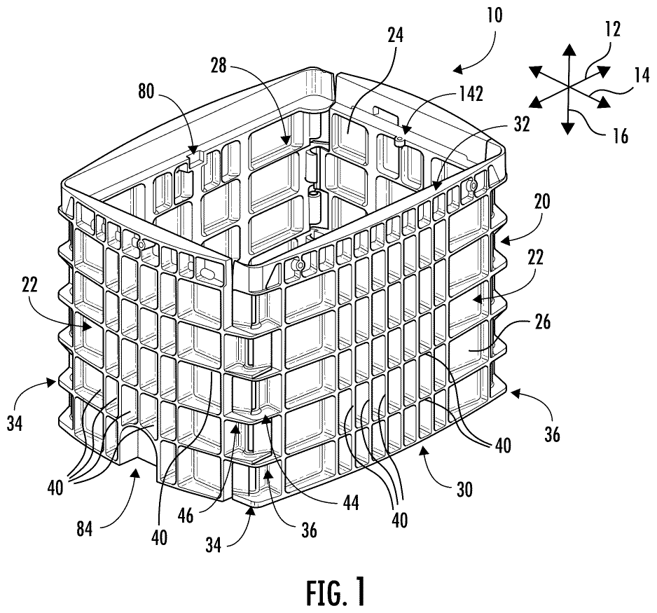

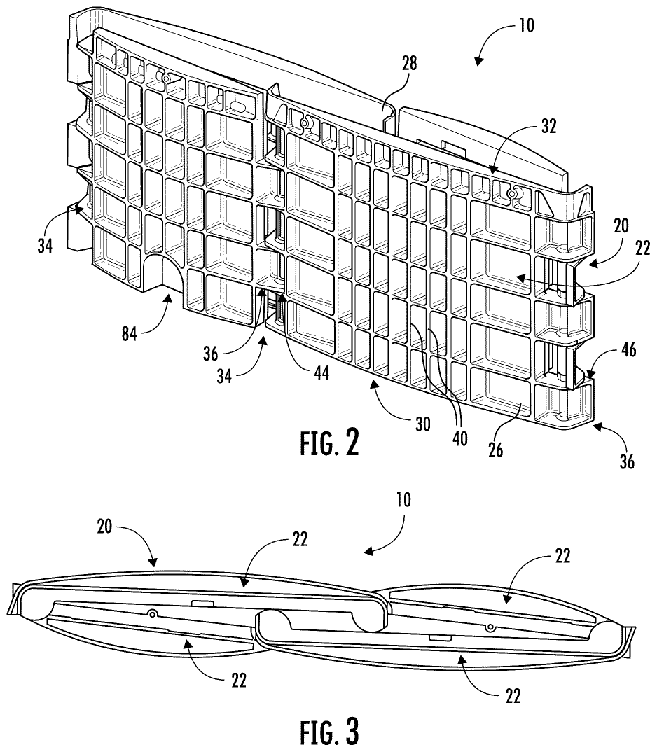

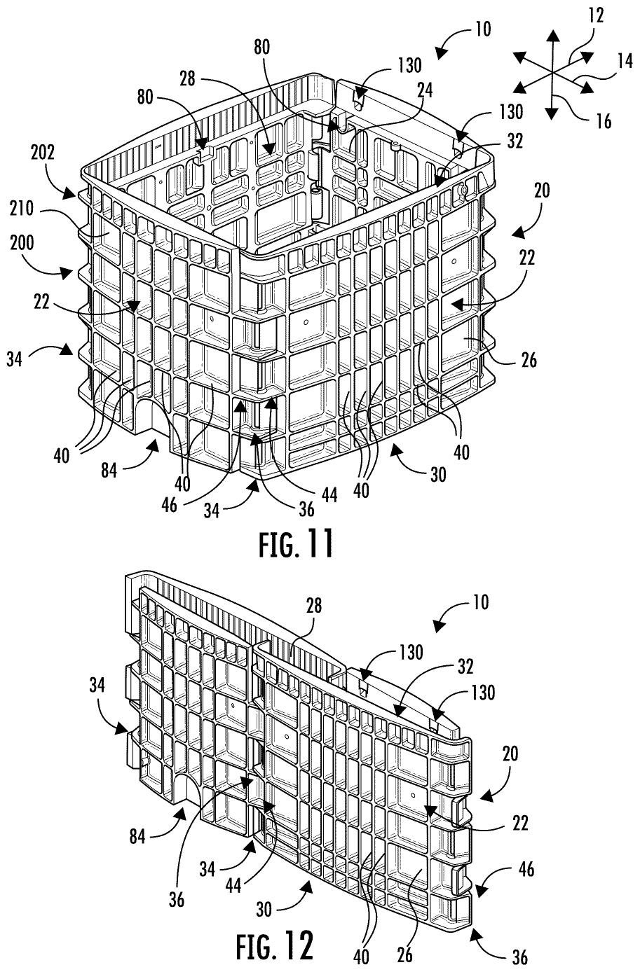

Referring now specifically to FIGS. 1, 2, 3, 11, and 12, in exemplary embodiments, the main body 20, and thus the plurality of panels 22 thereof, is movable between a folded position (see FIGS. 2, 3, and 12) and an expanded position (see FIGS. 1 and 11). In the expanded position, the size of the interior 28 is generally larger than in the folded position. In some embodiments, interior surfaces 24 of opposing panels 22 of the plurality of panels 22 may contact each other when in the folded position. The folded position advantageously allows for easier and more efficient transport of a larger number of handholes 10 on, for example, a truck or other suitable transportation vehicle. The main bodies 20 can then be expanded for use once the transportation vehicle is at an installation location.

In exemplary embodiments, each of the plurality of panels 22 is hingedly connected to others of the plurality of panels 22, such as to at least two others of the plurality of panels 22. Such hinged connection facilitates the movement of the main body 20 between the folded and expanded positions. For example, neighboring panels 22 may include on the first and second sides 34, 36 thereof overlapping end portions 44, 46 which facilitate such hinging. When assembled the first side 34 end portions 44 of a panel 22 may overlap with the second side 36 end portions 46 of a neighboring panel 22, as shown.

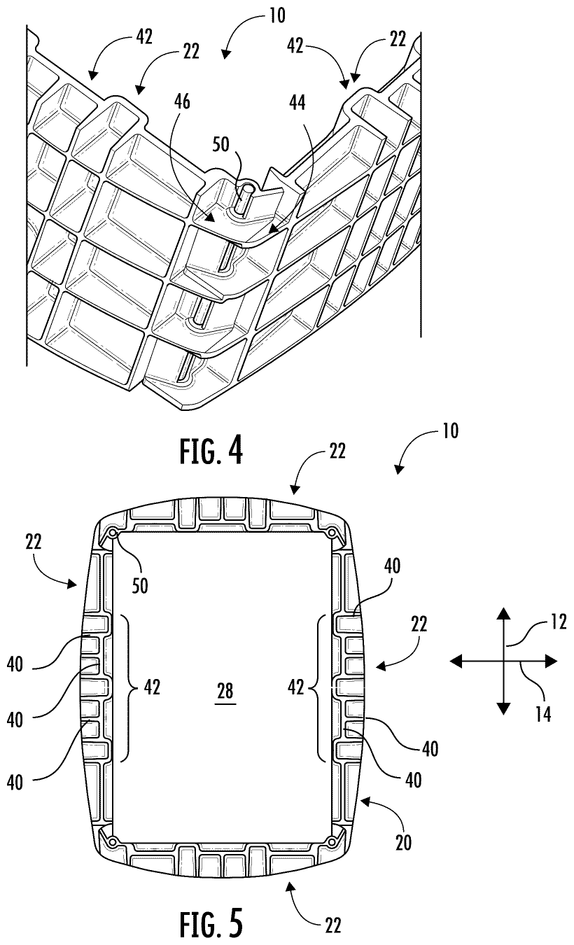

Referring now specifically to FIG. 4, in exemplary embodiments, main body 20 may further include a plurality of hinge pins 50. Each hinge pin 50 may hingedly connect neighboring panels 22, and may thus facilitate the movement of the main body 20 between the folded and expanded positions. The hinge pins 50 may extend along the vertical axis 16, as shown. A hinge pin 50 may, for example, extend through overlapping end portions 44, 46 (such as through apertures defined therethrough) to hingedly connect neighboring panels 22.

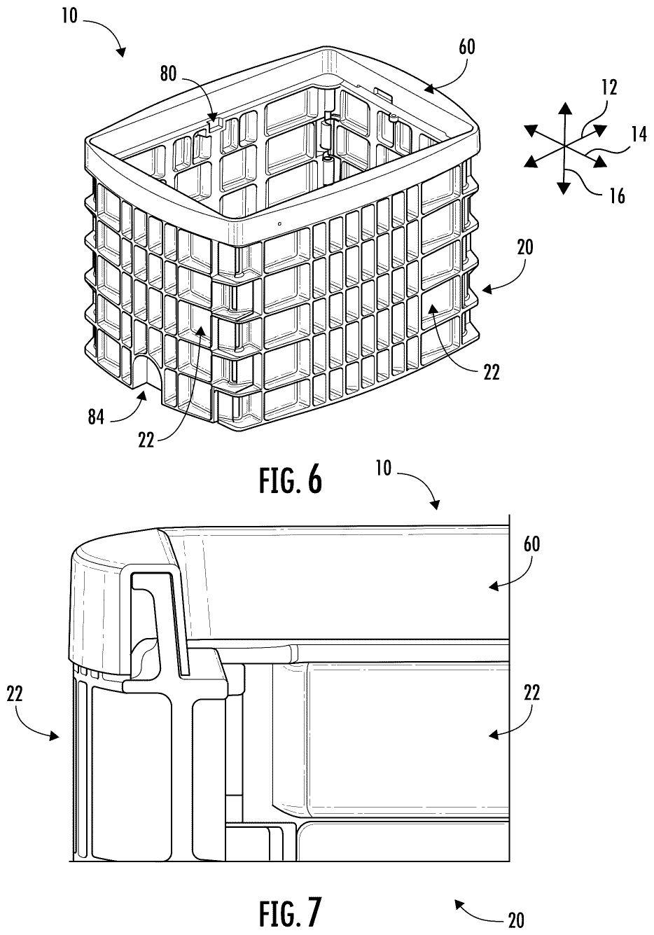

Referring now to FIGS. 6 and 7, in some embodiments, main body 20 may further include a collar 60. Collar 60 may, for example, have a generally U-shaped cross-sectional profile. Collar 60 may be insertable over and onto the tops 32 of all panels 22 in the main body 20 when the main body 20 is in the expanded position. The collar 60 may generally lock the panels 22 in place in the expanded position, and may provide additional hoop strength to the main body 20.

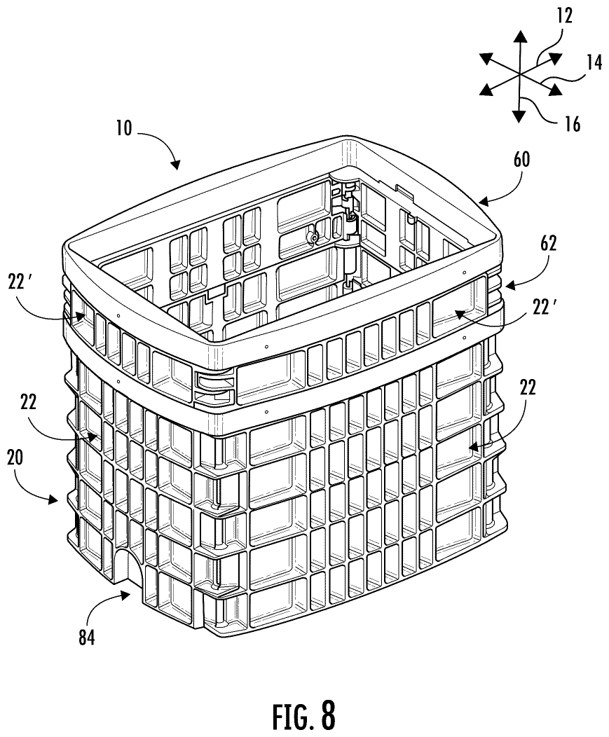

Referring now to FIG. 8, in some embodiments, handhole 10 may include a riser 62. Riser 62 may be an extension of the main body 20 which may increase the height of the main body 20 as needed. In exemplary embodiments riser 62 may include a plurality of panels 22′ which may include one or more characteristics of panels 22 as discussed herein. For example, panels 22′ may be formed from a foamed thermoplastic material, as discussed herein. Panels 22′ may further include ribs, as discussed herein. Panels 22′ may further be connected to each other, such as hingedly connected, as discussed herein. Riser 62 may be connected to main body 20, such that riser panels 22′ are connected to panels 22. Further, in some embodiments collar 60 may be insertable over and onto the tops of all panels 22′ in the riser 62 when the riser 62 is in the expanded position.

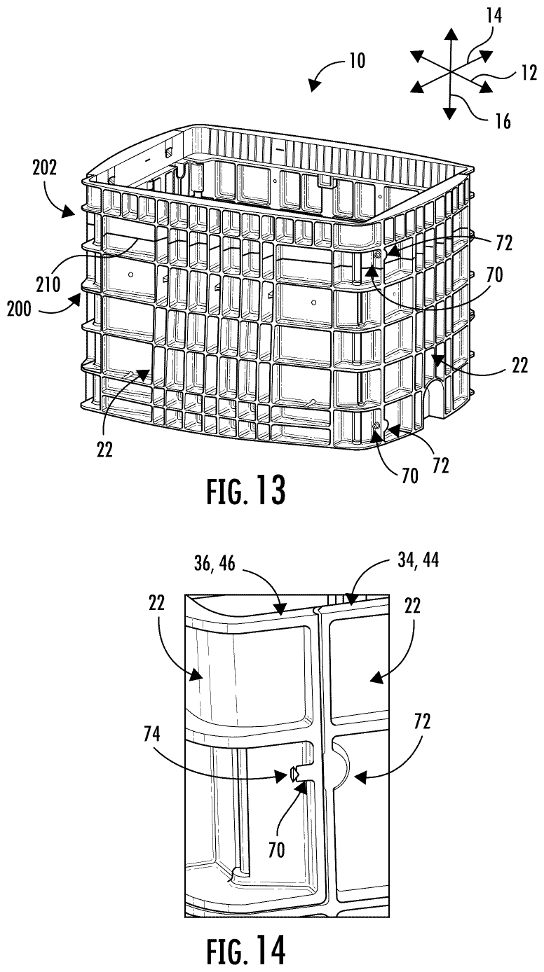

Referring now to FIGS. 13 and 14, in some embodiments, each of the plurality of panels 22 may include at least one of a fastener guide 70 and/or a fastener seat 72. In exemplary embodiments, each panel 22 includes a plurality of fastener guides 70 and/or fastener seats 72. The fastener guides 70 and/or fastener seats 72 may be disposed at the first side 34 and second side 36 of each of the plurality of panels 22, such as in exemplary embodiments on the exterior surface 26. When the main body 20 is in the expanded position, each fastener guide 70 may be proximate a fastener seat 72 of a neighboring panel 22. Thus, when the main body 20 is in the expanded position, a fastener 74 (e.g. a screw, bolt, rivet, etc.) may be extended through a fastener guide 70 of a panel 22 and a fastener seat 72 of a neighboring panel 22. The connection of the fastener seat 72 and fastener guide 70 together by a fastener 74 may generally lock the panels 22 together in the expanded position.

It should be understood that fastener guide 70 and fastener seat 72 may have the same or different configurations. The use of guide versus seat merely connotes the order through which a fastener 74 is extended, i.e. first through a fastener guide 70 and second through a fastener seat 72. Fastener seat 72 may, for example, have the same configuration as the fastener guide 70 and be open on both sides, or may be different from the fastener guide 70 and be open on only a single side.

Referring now to FIGS. 6, 11, 13, 15, and 18, in some embodiments cross-brace slots 80 may be defined in one or more panels 22, such as in the interior surface 24 thereof, for the removable insertion of cross-braces 82 therein. Cross-brace slots 80 may be defined in opposing panels 22, and a cross-brace 82 may be removable insertable into the slots 80 such that the cross-brace 82 extends across the interior 28 between the cross-brace slots 80. Inserting the cross-brace 82 into the slots 80 may provide additional structural support to the main body 20 and handhole 10 generally.

In some embodiments, slots 80 may be defined proximate the top 32 of panels 22, as illustrated. Additionally or alternatively, slots 80 may be defined proximate the bottom 30 or between the top 32 and bottom 30 along the vertical axis 16. Cross-braces 82 may, in exemplary embodiments, extend along the longitudinal axis 12 between opposing panels 22 or along the lateral axis 14 between opposing panels 22.

Referring now to FIGS. 1, 2, 6, 8, 10, 11-13, and 15-18, in some embodiments, one or more channels 84 may be defined in one or more of the panels 22. Each channel 84 may extend between and be defined in the interior surface 24 and the exterior surface 26, and may thus allow access to the interior 28 from exterior to the handhole 10. In some embodiments, a channel 84 may be defined proximate the bottom 30, as illustrated. Additionally or alternatively, channels 84 may be defined proximate the top 32 or between the top 32 and bottom 30 along the vertical axis 16.

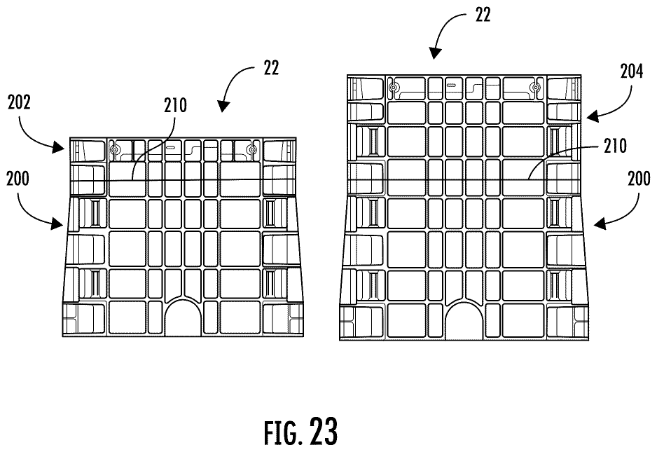

Referring now to FIGS. 13, 15, and 23, in exemplary embodiments, the panels 22 may be formed from a molding process. Further, in exemplary embodiments, each panel 22 may be formed from at least two of a plurality of modular molds. The plurality of modular molds may be a group of molds, each of which may be utilized to form a portion of a panel 22 and each of which may be compatible with at least one other mold from the group of molds to form a panel 22. For example, reference number 200 illustrates a first panel portion formed from a first panel portion mold. Reference number 202 illustrates a second panel portion formed from a second panel portion mold. Reference number 204 illustrates a third panel portion formed from a third panel portion mold. In the embodiments shown, portion 200 is a body portion, while 202 is a small top portion and 204 is a large top portion. In embodiments where a smaller size (e.g. height) panel 22 is required, molds for portions 200 and 202 may be utilized. Panels 22 formed using these molds form main bodies 20 as shown in FIG. 13. In embodiments where a larger size (e.g. height) panel 22 is required, molds for portions 200 and 204 may be utilized. Panels 22 formed using these molds form main bodies 20 as shown in FIG. 15. A comparison of panels 22 formed using these modular molds is shown in FIG. 23. Seam 210 defines the portions 200, 202, 204.

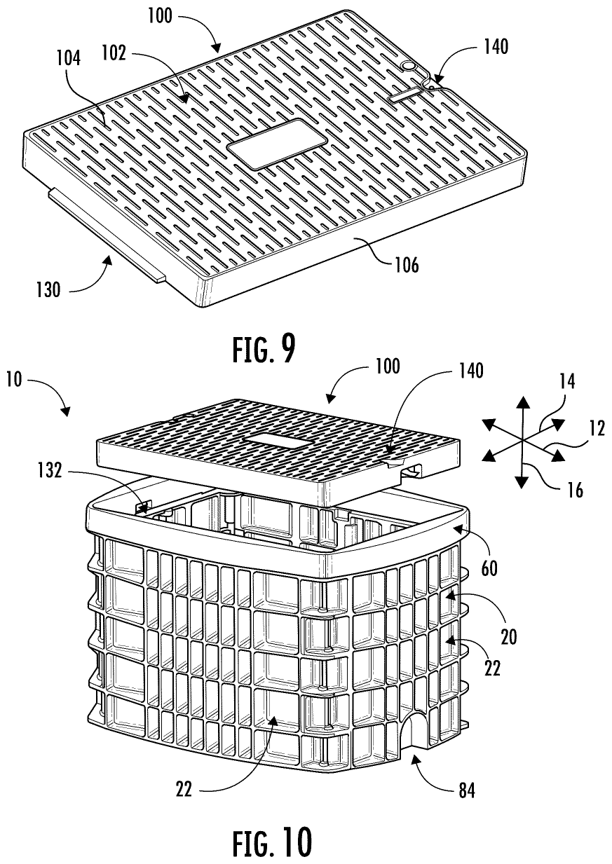

Referring now to FIGS. 9, 10, 16, 17, and 19-22, in exemplary embodiments, a handhole 10 in accordance with the present disclosure further includes a cover 100. Covers 100 in accordance with the present disclosure may high strength-to-weight ratios, be relatively lightweight and easy to transport, and include features which allow for secure connections to the handhole main bodies 20.

A cover 100 in accordance with the present disclosure may an upper portion 102 which includes an exterior surface 104, and may further include a sidewall 106 extending below the upper portion 102 and defining a periphery of the cover 100. Further, one or more laterally and/or longitudinally extending ribs 110 may be included below upper portion 102 and within an interior 108 defined by upper portion 102 and sidewall 106.

In exemplary embodiments, the cover 100 may be formed from a fiber-reinforced polymer material. In some embodiments, the polymer material is a thermoplastic. In some embodiments, the thermoplastic may be a polyethylene, such as for example a high-density polyethylene. Alternatively, in some embodiments, the thermoplastic may be a polyurethane, such as for example a high-density polyurethane. Alternatively, in some embodiments, the thermoplastic may be a polypropylene, such as for example a high-density polypropylene. Alternatively, in other embodiments, the thermoplastic may be a polyester. In other embodiments, the polymer material is a thermoset. In some embodiments, the thermoset is a polyester. In some embodiments, the thermoset may be thermoset sheet molding compound. Glass fibers or carbon fibers may be utilized to reinforce the polymer material.

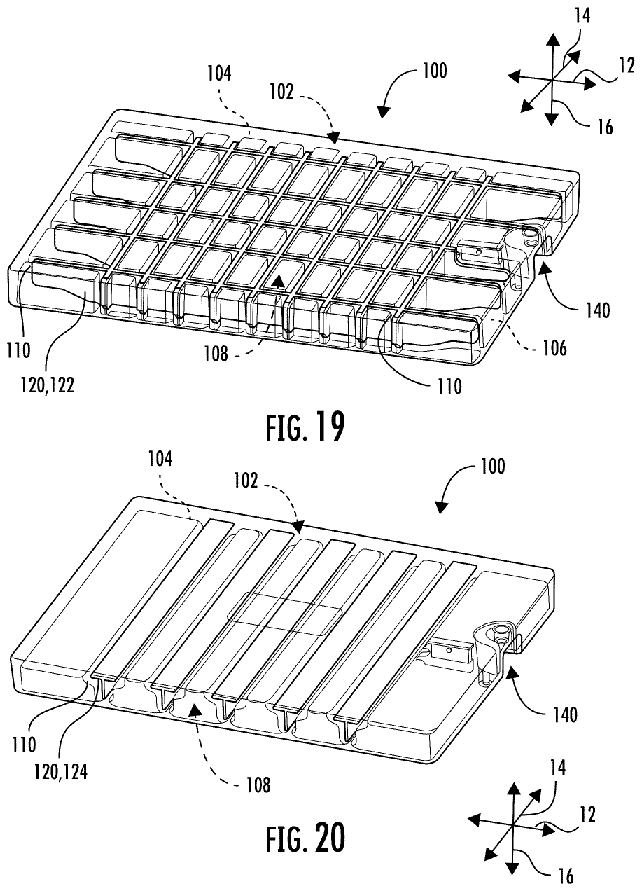

In exemplary embodiments, as illustrated in FIGS. 19 through 22, strength rods 120 may be embedded in the fiber-reinforced material to further reinforce the cover 100. For example, in exemplary embodiments rods 120 may be embedded in ribs 110.

In some embodiments, as shown in FIG. 19, the strength rods 120 may be cast metal members 122. The cast metal members 122 may be arranged in a grid, such as including laterally and longitudinally extending members as shown, or include only parallel laterally extending members or parallel longitudinally extending members.

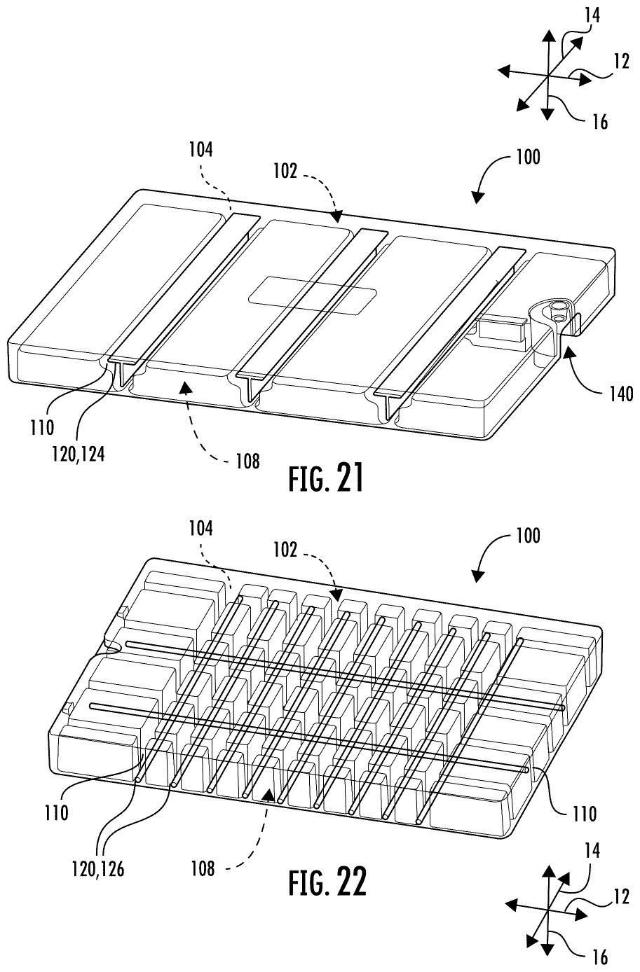

In some embodiments, as shown in FIGS. 20 and 21, the strength rods 120 may be T-bars 124. The T-bars 124 may be metal or may be formed from a pultruded reinforced polymer material. The T-bars 124 may be arranged in a grid, such as including laterally and longitudinally extending members, or include only parallel laterally extending members as shown or parallel longitudinally extending members. FIG. 20 illustrates five T-bars 124, while FIG. 21 illustrates three T-bars 124.

In some embodiments, as shown in FIG. 22, the strength rods 120 may be cylindrical rods 126. The cylindrical rods 126 may be metal (e.g. rebar) or may be formed from a pultruded reinforced polymer material. The cylindrical rods 126 may be arranged in a grid, such as including laterally and longitudinally extending members, or include only parallel laterally extending members as shown or parallel longitudinally extending members.

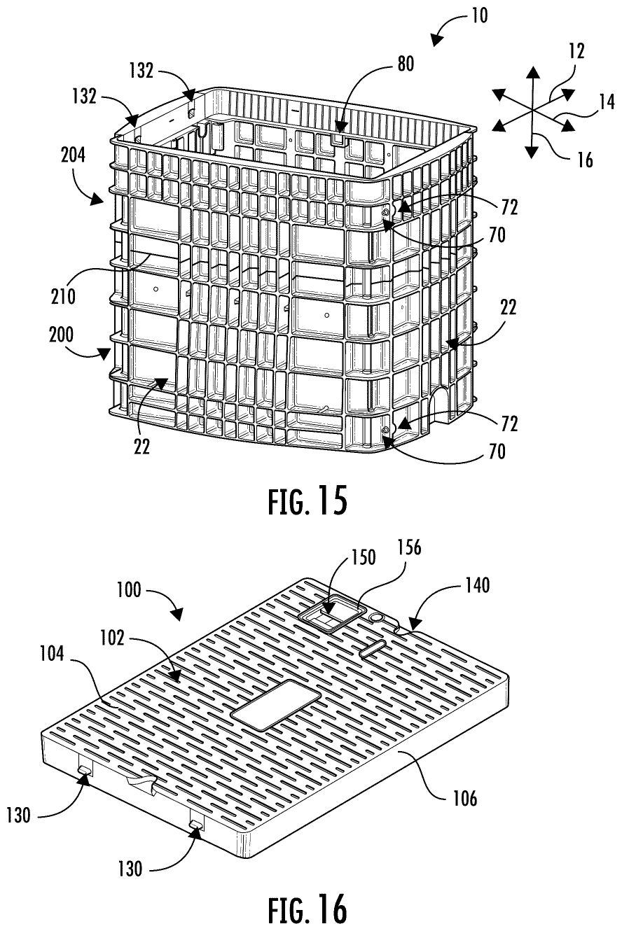

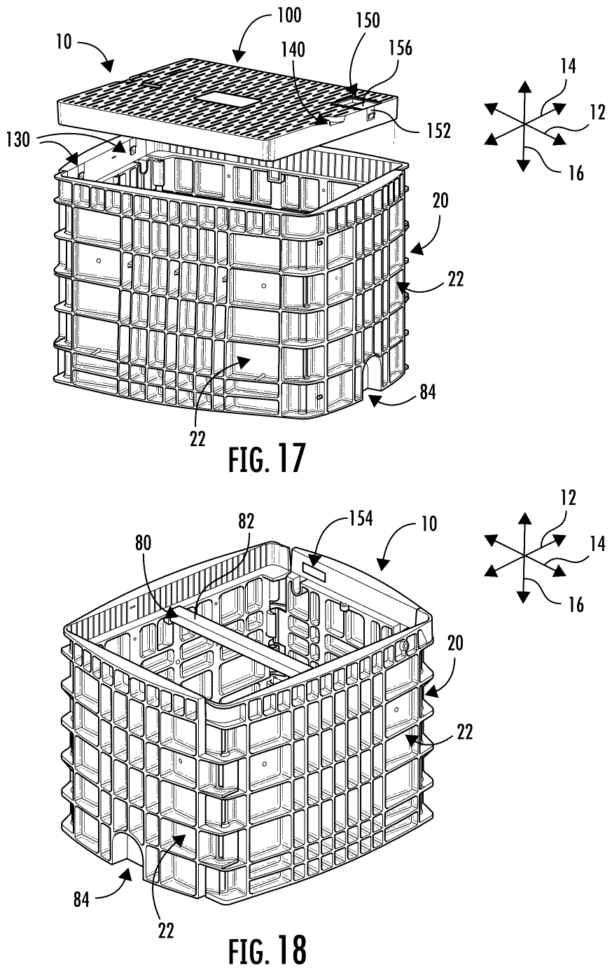

Referring now to FIGS. 9, 10, 16, and 17, in some embodiments, a cover 100 may include one or more locating tabs 130. The locating tabs 130 may extend outwardly from the main body of the cover, and may be removably insertable into locating slots 132 defined in one or more panels 22, such as in the interior surfaces 24 of such panels 22. In some embodiments, a cover 100 may include a single elongated tab 130, as illustrated in FIGS. 9 and 10, while in other embodiments, a cover 100 may include a plurality of discrete tabs 130, as illustrated in FIGS. 16 and 17. The locating tabs 130 may facilitate an initial connection of the cover 100 to the main body 20, and may further assist in securing the cover 100 to the main body 20.

Referring now to FIGS. 9 and 16, in some embodiments, a cover 100 may include a locking aperture 140 defined through the main body thereof. A locking fastener may be insertable through the locking aperture 140 and through a mating locking body 142 defined in the main body 20 to secure the cover 100 to the main body 20.

Additionally or alternatively, in exemplary embodiments, a cover 100 may include a slam latch 150. Slam latch 150 may include a shaft 152 which is removably insertable in a latch slot 154 defined in one of the plurality of panels 222, such as in the interior surface 24 of one of the plurality of panels 22. The slam latch 150 may further include a user-actuated lever 156 that, when activated (e.g. pulled) retracts the shaft 152 such that the shaft is removed from the latch slot 154. The slam latch 150 may also include a spring that biases the shaft 152 towards an extended position wherein the shaft 152 is extended and may be disposed in the latch slot 154. Slam latch 150 may further secure the cover 100 to the main body 20.

Handholes in accordance with various embodiments of the present disclosure may further include one or more features as disclosed in International Patent Application No. WO 2021/146472A1; U.S. Pat. Nos. 11,008,134; 11,066,802; U.S. patent application Ser. No. 17/223,089; U.S. patent application Ser. No. 17/224,155; and/or U.S. patent application Ser. No. 17/322,120, the disclosures of all of which is incorporated by reference herein in their entireties.

Further aspects of the disclosure are provided by one or more of the following embodiments:

A utility handhole including a main body including a plurality of panels, each of the plurality of panels including an interior surface and an exterior surface and defining a plurality of ribs. At least a portion of the plurality of ribs extend along a vertical axis and are connected to form an integral panel backbone. Each of the plurality of panels is hingedly connected to at least two others of the plurality of panels, such that the main body is movable between a folded position and an expanded position. Each of the plurality of panels is formed from a foamed thermoplastic material.

A utility handhole including a main body including a plurality of panels, each of the plurality of panels including an interior surface and an exterior surface and defining a plurality of ribs. At least a portion of the plurality of ribs extend along a vertical axis and are connected to form an integral panel backbone. Each of the plurality of panels is formed from a foamed thermoplastic material. The utility handhole further includes a cover. The cover includes a plurality of strength rods embedded in a fiber-reinforced thermoset material. The strength rods are defined in ribs formed by the fiber-reinforced thermoset material.

A utility handhole of any one or more embodiments shown or described herein, wherein each of the plurality of panels is hingedly connected to at least two others of the plurality of panels, such that the main body is movable between a folded position and an expanded position.

A utility handhole of any one or more embodiments shown or described herein, wherein the foamed thermoplastic material is a polypropylene.

A utility handhole of any one or more embodiments shown or described herein, wherein the foamed thermoplastic material does not include reinforcing fibers.

A utility handhole of any one or more embodiments shown or described herein, wherein each of the plurality of ribs extends between and is defined by the interior surface and the exterior surface.

A utility handhole of any one or more embodiments shown or described herein, further including a plurality of hinge pins, each of the plurality of hinge pins hingedly connecting neighboring panels of the plurality of panels.

A utility handhole of any one or more embodiments shown or described herein, wherein each of the plurality of panels defines a fastener seat and a fastener guide, and wherein a fastener extends through the fastener guide of one of the plurality of panels and the fastener seat of another of the plurality of panels when the main body is in the expanded position.

A utility handhole of any one or more embodiments shown or described herein, wherein cross-brace slots are defined in the interior surface of opposing panels of the plurality of panels, and wherein a cross-brace is removable insertable into the cross-brace slots.

A utility handhole of any one or more embodiments shown or described herein, wherein a channel is defined in one of the plurality of panels, the channel extending between and defined in the interior surface and the exterior surface of that one of the plurality of panels.

A utility handhole of any one or more embodiments shown or described herein, further including a cover, the cover formed from a fiber-reinforced polymer material.

A utility handhole of any one or more embodiments shown or described herein, wherein the cover further includes a plurality of strength rods embedded in the fiber-reinforced polymer material.

A utility handhole of any one or more embodiments shown or described herein, wherein the fiber-reinforced polymer material is a fiber-reinforced thermoset material, and wherein the strength rods are defined in ribs formed by the fiber-reinforced thermoset material.

A utility handhole of any one or more embodiments shown or described herein, wherein the cover includes a locating tab, the locating tab removably insertable in a locating slot defined in the interior surface of one of the plurality of panels.

A utility handhole of any one or more embodiments shown or described herein, wherein the cover further includes a slam latch, the slam latch including a shaft which is removably insertable in a latch slot defined in the interior surface of one of the plurality of panels.

A utility handhole of any one or more embodiments shown or described herein, wherein each of the plurality of panels is formed from at least two modular molds of a plurality of modular molds.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A utility handhole, comprising:
a main body comprising a plurality of panels, each of the plurality of panels comprising an interior surface and an exterior surface and defining a plurality of ribs, wherein at least a portion of the plurality of ribs extend along a vertical axis and are connected to form an integral panel backbone,
wherein each of the plurality of panels is hingedly connected to at least two others of the plurality of panels, such that the main body is movable between a folded position and an expanded position, and
wherein each of the plurality of panels is formed from a foamed thermoplastic material

2. The utility handhole of claim 1, wherein the foamed thermoplastic material is a polypropylene.

3. The utility handhole of claim 1, wherein the foamed thermoplastic material does not include reinforcing fibers.

4. The utility handhole of claim 1, wherein each of the plurality of ribs extends between and is defined by the interior surface and the exterior surface.

5. The utility handhole of claim 1, further comprising a plurality of hinge pins, each of the plurality of hinge pins hingedly connecting neighboring panels of the plurality of panels.

6. The utility handhole of claim 1, wherein each of the plurality of panels defines a fastener seat and a fastener guide, and wherein a fastener extends through the fastener guide of one of the plurality of panels and the fastener seat of another of the plurality of panels when the main body is in the expanded position.

7. The utility handhole of claim 1, wherein cross-brace slots are defined in the interior surface of opposing panels of the plurality of panels, and wherein a cross-brace is removable insertable into the cross-brace slots.

8. The utility handhole of claim 1, wherein a channel is defined in one of the plurality of panels, the channel extending between and defined in the interior surface and the exterior surface of that one of the plurality of panels.

9. The utility handhole of claim 1, further comprising a cover, the cover formed from a fiber-reinforced polymer material.

10. The utility handhole of claim 9, wherein the cover further comprises a plurality of strength rods embedded in the fiber-reinforced polymer material.

11. The utility handhole of claim 10, wherein the fiber-reinforced polymer material is a fiber-reinforced thermoset material, and wherein the strength rods are defined in ribs formed by the fiber-reinforced thermoset material.

12. The utility handhole of claim 9, wherein the cover comprises a locating tab, the locating tab removably insertable in a locating slot defined in the interior surface of one of the plurality of panels.

13. The utility handhole of claim 9, wherein the cover further comprises a slam latch, the slam latch comprising a shaft which is removably insertable in a latch slot defined in the interior surface of one of the plurality of panels.

14. The utility handhole of claim 1, wherein each of the plurality of panels is formed from at least two modular molds of a plurality of modular molds.

15. A utility handhole, comprising:
a main body comprising a plurality of panels, each of the plurality of panels comprising an interior surface and an exterior surface and defining a plurality of ribs, wherein at least a portion of the plurality of ribs extend along a vertical axis and are connected to form an integral panel backbone, wherein each of the plurality of panels is formed from a foamed thermoplastic material; and
a cover, the cover comprising a plurality of strength rods embedded in a fiber-reinforced thermoset material, wherein the strength rods are defined in ribs formed by the fiber-reinforced thermoset material.

16. The utility handhole of claim 15, wherein the foamed thermoplastic material is a polypropylene.

17. The utility handhole of claim 15, wherein each of the plurality of ribs extends between and is defined by the interior surface and the exterior surface.

18. The utility handhole of claim 15, wherein each of the plurality of panels is hingedly connected to at least two others of the plurality of panels, such that the main body is movable between a folded position and an expanded position, and further comprising a plurality of hinge pins, each of the plurality of hinge pins hingedly connecting neighboring panels of the plurality of panels.

19. The utility handhole of claim 15, wherein each of the plurality of panels defines a fastener seat and a fastener guide, and wherein a fastener extends through the fastener guide of one of the plurality of panels and the fastener seat of another of the plurality of panels when the main body is in the expanded position.

20. The utility handhole of claim 15, wherein the cover further comprises a slam latch, the slam latch comprising a shaft which is removably insertable in a latch slot defined in the interior surface of one of the plurality of panels.

21. The utility handhole of claim 15, wherein each of the plurality of panels is formed from at least two modular molds of a plurality of modular molds.
